(19) United States
(12) Patent Application Publication
(10) Pub. No.: US 2003/0105872 A1
(43) Pub. Date: Jun. 5, 2003

(54) Data interfacing method and apparatus

(75) Inventors: Dong-Hyeop Han, Seoul (KR); Seung-Soo Oak, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-City (KR)

(21) Appl. No.: 10/307,459

(22) Filed: Dec. 2, 2002

(30) Foreign Application Priority Data
Dec. 1, 2001 (KR) 2001-75674

(51) Int. Cl. G06F 15/16

(52) U.S. Cl. 709/229; 709/237

(57) ABSTRACT

An interface apparatus and method of interfacing an external user with at least one data processor having at least one port. The apparatus determines whether the user's data transceiving with the data processor in a packet is authenticated and/or authorized, using the packet received from the user. The data provided from an authenticated and/or authorized user is transmitted to the data processor or the data provided from the data processor is transmitted to the authenticated and/or authorized user, if it is determined that the user's transceiving of data with the data processor is authenticated and/or authorized. Therefore, an authenticated and/or authorized external user can use a corresponding data processor or remotely check a state (e.g., a trouble state) of the data processor in advance or in real-time without setting specific software in the interface apparatus. Further, unnecessary advertising pamphlets and leaflets can be prevented from being printed by the external user.

### CROSS-REFERENCE TO RELATED APPLICATIONS

This application claims the benefit of Korean Application No. 2001-75674 filed Dec. 1, 2001, in the Korean Intellectual Property Office, the disclosure of which is incorporated herein by reference.

### BACKGROUND OF THE INVENTION

1. Field of the Invention

The present invention relates to data transmission, and more particularly, to a data interfacing method and an apparatus controlling data transmission between internal resources having information that should be protected and external users.

2. Description of the Related Art

A printing process will be used as an example data communication between an external user and printers as the internal resources of a network. A conventional printing method via a network can be classified into a network printing method and an Internet printing method. Here, the network printing method performs printing over Intra-net and the Internet printing method performs printing over the Internet. The Internet printing method performs printing via a gateway which interfaces the Internet (external user) with the Intra-net (internal resources).

A user may transmit printing data to an internal print server (not shown) linked to the Intra-net if a firewall is not installed in the gateway (not shown). In other words, an external user can link to the internal print server using Internet Printing Protocol (IPP). Here, to respond to the user, the internal print server receives a packet containing the external user's request for the link to the internal print server. The user perceives (determines) success in linking to the internal print server and checks the state of an internal printer (not shown) linked to the internal print server using IPP, if the user receives a response from the internal print server. If the internal printer is idle, the user transmits printing data to the internal print server using an operator “Send Job” of IPP. Here, the internal print server, which received printing data, analyzes a header in a packet and transmits printing data to the internal printer in various transmission ways. Thus, the internal printer, which received printing data from the internal print server, can print a document corresponding to printing data.

However, in a case where the firewall is installed in the gateway, the user can transmit printing data to the internal print server only if the user receives the authorization of the firewall. In other words, with a firewall, if the external user tries to link to the internal print server, the firewall prevents a packet from reaching the internal print server. Here, a port can artificially be opened to pass the packet through the firewall so that the user's packet can be transmitted to the internal print server. However, the conventional method of printing the external user's printing data by using the internal printer over the network having the firewall via the artificially opened port has the following problems: information of all available internal resources linked to the Intra-net via the opened port can be drained out to (retrieved by) an unauthenticated and/or unauthorized external user and an unauthenticated and/or unauthorized external user can use the internal printer.

To overcome these problems, an additional external print server linked to the Internet instead of the Intra-net can be used. In other words, the user transmits printing data corresponding to a document to be printed to the external print server and the external printer server stores printing data. Here, a network card built in an external printer (not shown) linked to the external print server inquires of the external print server about whether the external print server has printing data every predetermined time to check whether printing data to be printed exists. If printing data exists, the external printer receives corresponding printing data and prints a corresponding document. However, the conventional printing method by which the external user uses the external print server for printing requires an additional external print server and additional resources for managing the external print server. Thus, this conventional printing way increases costs.

### SUMMARY OF THE INVENTION

To solve at least the above-described problems, a first object of the present invention is to provide a data interfacing method controlling data transceiving between at least one internal resource having information that should be protected and an external user without unauthorized drain (output) of the information.

A second object of the present invention is to provide a data interfacing apparatus performing the above data interfacing method of the invention.

Additional objects and advantages of the invention will be set forth in part in the description which follows and, in part, will be obvious from the description, or may be learned by practice of the invention.

According to an embodiment of the invention, there is provided a method of interfacing an external user with at least one data processor having at least one port by determining whether the user's transceiving of data with the data processor in a packet is authenticated, using the packet received from the user. The data provided from the authenticated user is transmitted to the data processor or data provided from the data processor is transmitted to the authenticated user, if the user's transceiving of data with the data processor is authenticated. In an aspect of the invention, if the data transceiving by the user is authenticated, the data processor processes the data provided from the user.

According to another embodiment of the invention, there is provided an apparatus interfacing an external user with at least one data processor having at least one port, the apparatus comprising a control signal generator controlling a data transmission controller to control data communication between the external user and the one data processor. The control signal generator analyzes a packet input from the user, checks the analyzed result to determine whether the user's transceiving of data with the data processor in a packet is authenticated, and outputs an authentication control signal to the data transmission controller, in response to the checked result. The data transmission controller outputs the data input from the authenticated user to the data processor or outputs the data input from the data processor to the authenticated user in response to the authentication control signal. According to an aspect of the invention, if the data transceiving by the user is authenticated, the data processor processes the data input from the user via the data transmission controller.

### BRIEF DESCRIPTION OF THE DRAWINGS

The above and other objects and advantages of the present invention will become more apparent by describing in detail preferred embodiments thereof with reference to the attached drawings in which:

FIG. 1 is a flowchart of a data interfacing method according to an embodiment of the present invention;

FIG. 2 is a block diagram of a data interfacing apparatus performing the data interfacing method shown in FIG. 1, according to an embodiment of the present invention;

FIG. 3 is a flowchart of a first embodiment of operation 10 shown in FIG. 1;

FIG. 4 is a block diagram of control signal generators performing first and second embodiments of operation 10 shown in FIGS. 3 and 5, according to embodiments of the present invention;

FIG. 5 is a flowchart of a second embodiment of operation 10 shown in FIG. 1;

FIG. 6 is a flowchart of operations 54 or 96 shown in FIGS. 3 or 5;

FIG. 7 is a block diagram of an authentication determiner performing the embodiment of operations 54 or 96 shown in FIG. 6;

FIG. 8 is a flowchart of operation 100 shown in FIG. 5;

FIG. 9 is a block diagram of an authentication determiner performing the embodiment of operation 100 shown in FIG. 8;

FIG. 10 is a block diagram of a data transmission controller shown in FIG. 2; and

FIG. 11 is a block diagram of a data communication system adopting a data interfacing apparatus shown in FIG. 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures. In particular, a data interfacing method and a configuration and operation of a data interfacing apparatus performing the same will be described with reference to the attached drawings.

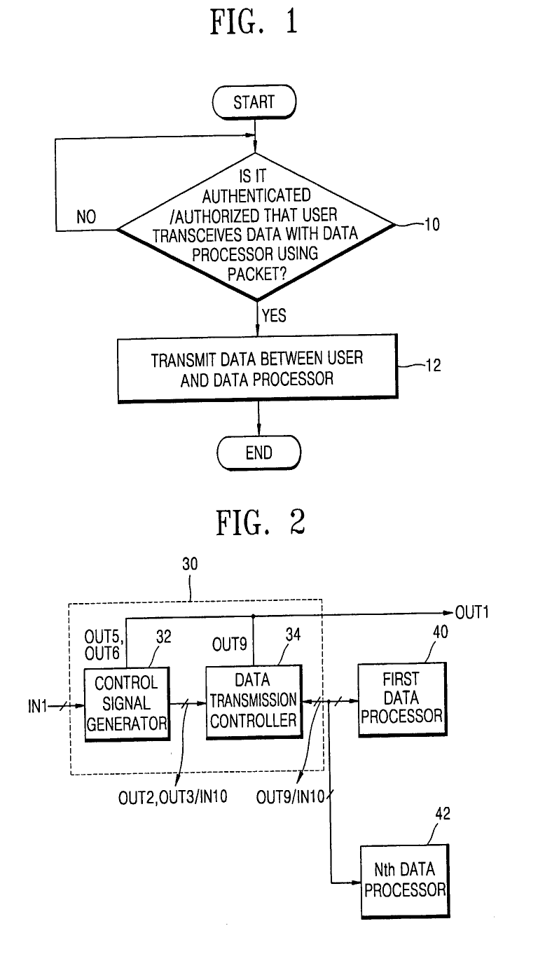

FIG. 1 is a flowchart of a data interfacing method according to an embodiment of the present invention, which comprises operations 10 and 12 where a user transceives data with a data processor depending on whether the user's transceiving of data with the data processor is authenticated and/or authorized. More particularly, operation 10 is an authentication and/or authorization process and operation 12 is a data communication process. In the present invention, typically authentication refers to confirming identity of a user, which may also include verifying the validation of user's authority.

FIG. 2 is a block diagram of a data interfacing apparatus (computer system) performing the data interfacing method of FIG. 1, according to an embodiment of the present invention. In FIG. 2, a data interfacing apparatus 30 is in communication with first through Nth (here, N is a positive fixed number of 1 or more) data processors 40, . . . , and 42. The data interfacing apparatus 30 comprises a control signal generator 32 and a data transmission controller 34.

The data interfacing method shown in FIG. 1 controls the transceiving of data between at least one of the first through Nth data processors 40, . . . , and 42 having at least one port (i.e., an endpoint to a logical connection in Internet protocol networks) and an external user.

According to a first embodiment of the present invention, at operation 10, it is determined whether a user's transceiving of data with one of the first through Nth data processors 40, . . . , and 42 is authenticated, using a packet received from the user. In particular, at operation 10, the control signal generator 32 of the data interfacing apparatus 30 analyzes a packet received, via an input node IN1, from the user, checks from the analyzed result whether the user's transceiving of data with one of the first through Nth data processors 40, . . . , and 42 using the packet is authenticated, and outputs an authentication control signal, generated in response to the checked result, to the data transmission controller 34. According to an aspect of the present invention, data input via the input node IN1 can be provided from the user at a computing unit, typically a computer, via a network, e.g., the Internet, Intra-net, or a single transmission line.

If, at operation 10, it is determined that the user's transceiving of data with one of the first through Nth data processors 40, . . . , and 42 using the packet is authenticated, at operation 12, data provided from the authenticated user is transmitted to a corresponding data processor 40, . . . , and 42 or data provided from the corresponding data processor 40, . . . , and 42 is transmitted to the authenticated user. In particular, the data transmission controller 34 of the data interfacing apparatus 30 outputs data input in a packet, via the input node IN1 and the control signal generator 32, from the authenticated user to a corresponding one of the first through Nth data processors 40, . . . , and 42 or outputs data input from the corresponding data processor 40, . . . , or 42 via an output node OUT1 to the authenticated user, in response to the authentication control signal input from the control signal generator 32.

According to a second embodiment of the present invention, at operation 10, it is determined whether a user's transceiving of data with a corresponding one of first through Nth data processors 40, . . . , and 42 is authenticated and authorized, using a received packet. In particular, in this aspect of the invention, the interface apparatus 30 authenticates a user as well as determines whether a desired data communication by the authenticated user is authorized (i.e., whether the authenticated user has the authority to perform the desired data communication). In this case, the control signal generator 32 shown in FIG. 2 analyzes a packet received, via the input node IN1, from the user, checks from the analyzed result whether the user and the user's transceiving of data with a corresponding data processor of first through Nth data processors 40, . . . , and 42 is, respectively, authenticated and authorized, and outputs authentication and authorization control signals, generated in response to the checked result, to the data transmission controller 34.

If, at operation 10, it is determined that the user and the user's transceiving of data with the corresponding data processor 40, . . . or 42 is authenticated and authorized, at operation 12, data provided from the authenticated user is transmitted to an authorized corresponding data processor 40, . . . or 42 of the first through Nth data processors 40, . . . , and 42 or data provided from the authorized data processor is transmitted to the authenticated user. In particular, at operation 12, the data transmission controller 34 outputs data input, via the input node IN1 and the control signal generator 32, from the authenticated user to the authorized data processor 40, . . . or 42 or outputs data input from the authorized data processor 40, . . . or 42 to the authenticated user via the output node OUT1, in response to the authentication and authorization control signals input from the control signal generator 32.

According to an aspect of the present invention, data output from the data interfacing apparatus 30 can be provided to a corresponding data processor of the first through Nth data processors 40, . . . , and 42 via a network, e.g., the Internet, the Intra-net, or a single transmission line.

For example, if the data interfacing apparatus 30 receives data from a user via the Internet and transmits data to one of the first through Nth data processors 40, . . . , and 42 via the Intra-net, the data interfacing apparatus 30 can serve as a firewall. In this case, unlike a conventional firewall, the data interfacing apparatus 30 can selectively open a specific port of a specific data processor to the user through authentication and/or authorization.

In FIG. 2, each first through Nth data processor 40, . . . , and 42 can process data input via the data interfacing apparatus 30 from the user. For example, an nth data processor (1≦n≦N) of the first through Nth data processors 40, . . . , and 42 may be a printer. In this case, the nth data processor 40, . . . or 42 prints information corresponding to printing data contained in a packet input from the input node IN1 via the data interfacing apparatus 30.

An example process of generating printing data will be described next. Typically, printing data is generated by a user when the user at a computer on a network (not shown) opens a document on a screen to be printed using a software application and instructs printing of the document. The printing data is transmitted to a graphical device interface (GDI) part (not shown). The GDI part translates the printing data using a printer driver (not shown). The printing data translated in the printer driver is transmitted to a spooler (not shown ) and the spooler performs spooling. The spooled data corresponds to the printing data, which is transmitted as user data to the interfacing apparatus 30 (input node IN1) via a network, such as the Internet.

According to an aspect of the present invention, the nth data processor 40, . . . or 42 can perform its own functions, e.g., perform printing or check its state, according to data (in response to commands) provided, via the data interfacing apparatus 30, from the user. In other words, if the nth data processor is a printer, the printer can check its state, i.e., the amount of consumed toner, paper jam, lack of sheets of paper, and printer trouble, according to data input, via the input node IN1 and the data interfacing apparatus 30, from the user and the printer can provide data regarding the checked state of the printer to the user. Accordingly, the interfacing apparatus 30 can authenticate and authorize a user to remotely control the first through Nth data processor 40, . . . , and 42 through the interfacing apparatus 30.

Hereinafter, the previously described first and second embodiments of operation 10 shown in FIG. 1 and a configuration and operation of the control signal generator 32 performing the first and second embodiments of operation 10, shown in FIG. 2, will be described in more detail.

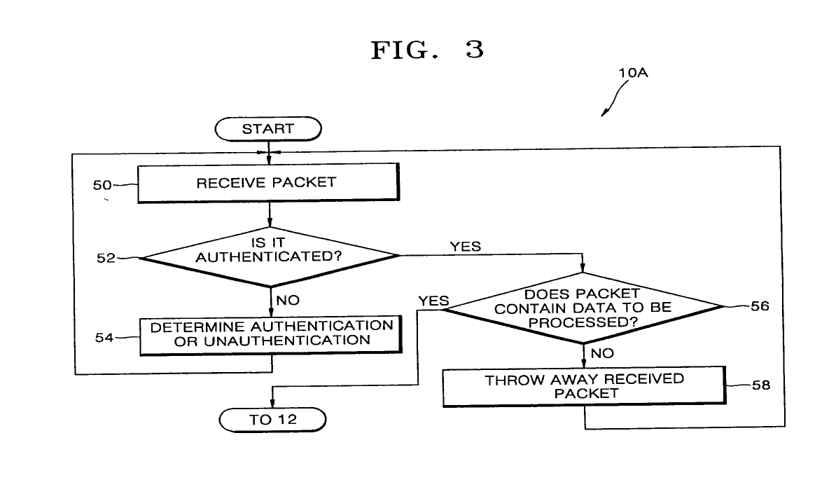

FIG. 3 is a flowchart of a first embodiment of operation 10 (operation 10A), comprising operations 50 through 58 determining authentication and unauthentication (i.e., no authentication) using a received packet.

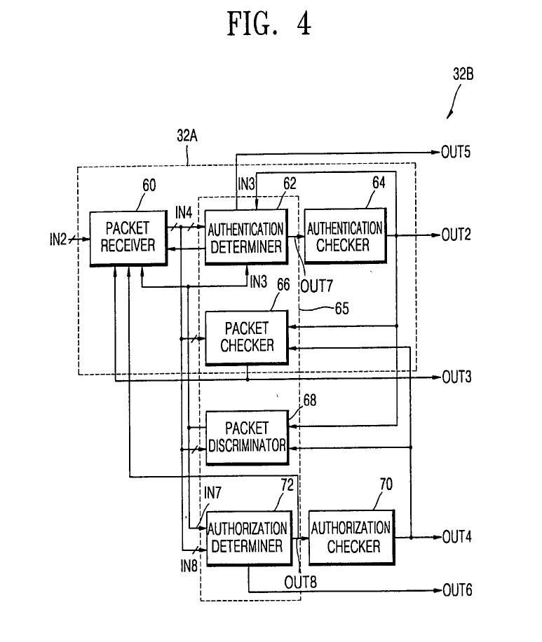

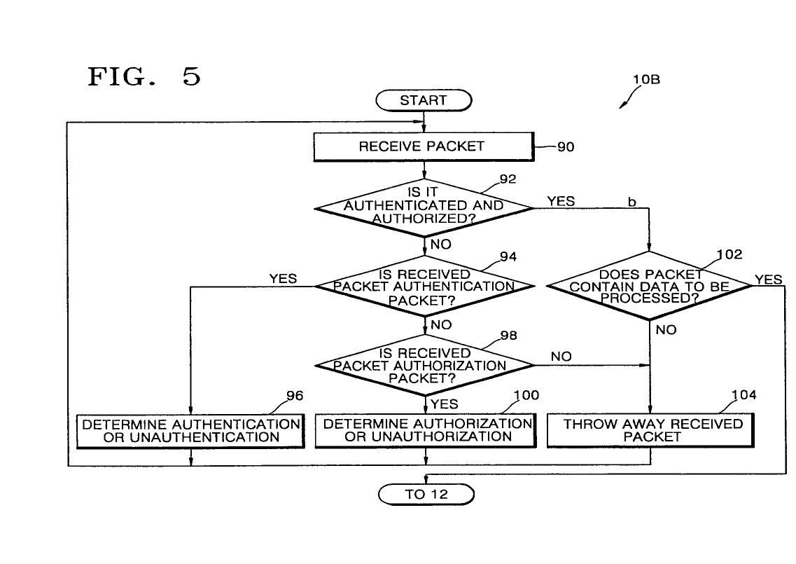

FIG. 4 is a block diagram of control signal generators 30 (control signal generators 32A and 32B) performing, respectively, the first and second embodiments of operation 10 shown in FIGS. 3 and 5, according to embodiments of the present invention. In FIG. 4, the control signal generator 32B comprises a packet receiver 60, an authentication determiner 62, an authentication checker 64, a packet checker 66, a packet discriminator 68, an authorization checker 70, and an authorization determiner 72.

In FIG. 4, to perform the first embodiment of operation 10 (i.e., operation 10A in FIG. 3), the control signal generator 32A may comprise the packet receiver 60, the authentication determiner 62, the authentication checker 64, and the packet checker 66.

In FIG. 3, at operation 50, the packet receiver 60 receives a packet from a user via an input node IN2 in response to receiving control signals input from the authentication determiner 62 and the packet checker 66. The packet receiver 60 goes into a receiving standby state regardless of the receiving control signals, if the packet receiver 60 does not receive the packet via the input node IN2 from the user.

At operation 52, it is determined whether the user's transceiving of data with a corresponding one of the first through Nth data processors 40, . . . , and 42 is authenticated. In particular, at operation 52, the authentication checker 64 checks determined authentication or unauthentication, input from the authentication determiner 62, to determine whether the user's data transceiving with the corresponding data processor is authenticated and outputs the checked result as an authentication control signal to the data transmission controller 34 via an output node OUT2.

At operation 54, the authentication or the unauthentication is determined using the received packet, if operation 52 determines that the user's transceiving of data with the corresponding data processor 40, . . . or 42 is unauthenticated. After operation 54, the authentication process 10A restarts at operation 50. In particular, at operation 54 the authentication determiner 62 analyzes the packet input from the packet receiver 60 in response to the authentication control signal input via IN3 from the authentication checker 64 and determines authentication or unauthentication based on the analyzed result. At operation 54, the authentication determiner 62 outputs a receiving control signal, generated in response to the determined authentication or unauthentication, to the packet receiver 60 and outputs the determined authentication or unauthentication to the authentication checker 64, which, at operation 52, checks the determined authentication from the authentication determiner 62.

If at operation 52, it is determined that the user's transceiving of data with the corresponding data processor 40, . . . or 42 is authenticated, at operation 56, it is determined whether the received packet contains data to be processed in the corresponding data processor 40, . . . or 42. In particular, at operation 56, the packet checker 66 of the control signal generator 32A checks whether the received packet input from the packet receiver 60 contains data to be processed in the corresponding data processor 40, . . . or 42, in response to the authentication control signal input from the authentication checker 64 and outputs the checked result to the data transmission controller 34 via an output node OUT3.

Therefore, operation 12 starts if it is determined at operation 56 that the received packet contains data to be processed. In other words, the data transmission controller 34 performs operation 12, if it is determined that the received packet contains data to be processed, based on the checked result output via the output node OUT3 from the packet checker 66.

However, if, at operation 56, it is determined that the received packet does not contain data to be processed, at operation 58, the received packet is thrown away and the authentication process 10A returns to operation 50. In other words, at operation 58, the packet receiver 60 throws away the received packet input from the input node IN2 in response to the checked result as a receiving control signal input from the packet checker 66 and the packet receiver 60 receives a new packet via the input node IN2 or goes into a receiving standby state.

FIG. 5 is a flowchart of a second embodiment of operation 10 (operation 10B), comprising operations 90 through 104 determining authentication or unauthentication and authorization or unauthorization (no authorization), using a received packet.

In FIG. 4, a control signal generator 32B performs the second embodiment of operation 10 (i.e., operation 10B in FIG. 5).

In FIG. 5, at operation 90, the packet receiver 60 receives a packet via the input node IN2 from a user or goes into a receiving standby state in response to receiving control signals input from the authentication determiner 62, the packet checker 66, the packet discriminator 68, and/or the authorization determiner 72.

At operation 92, it is determined whether a user's transceiving of data with a corresponding one of first through Nth data processors 40, . . . , and 42 is authenticated and authorized. In particular, at operation 92 it is determined whether the authentication checker 64 has output an authentication control signal generated due to the previously described operation 52 via the output node OUT2. Further, at operation 92, the authorization checker 70 checks determined authorization or unauthorization input from the authorization determiner 72 to determine whether the user's data transceiving with the corresponding data processor is authorized and outputs the checked result as an authorization control signal via an output node OUT4.

At operation 94, it is determined whether the received packet is an authentication packet, if at operation 92 it is determined that the user's data transceiving with the corresponding data processor is unauthenticated or unauthorized. Typically, the authentication packet comprises a first identifier identifying a user and a second identifier identifying one of the first through Nth data processors 40, . . . , and 42 related to the user. For example, the first identifier can correspond to at least one of the identification (ID) and password of the user. The second identifier can contain information, e.g., a network protocol address, identifying one of the first through Nth data processors 40, . . . , and 42, which can be assigned to the user in advance.

At operation 96, the authentication or unauthentication is determined using the received packet, if at operation 94 it is determined that the received packet is the authentication packet. After operation 96, the authentication and authorization process 10B restarts at operation 90. In particular, at operation 96, the authentication determiner 62 performs the same operation 54 as previously described, in response to a packet discrimination signal input from the packet discriminator 68. In other words, at operation 96, the authentication determiner 62 analyzes the packet input from the packet receiver 60 in response to the packet discrimination signal input from the packet discriminator 68 and the authentication control signal input from the authentication checker 64, determines the authentication or unauthentication based on the analyzed result, and outputs the determined authentication or unauthentication to the authentication checker 64, which, at operation 92, checks the determined authentication from the authentication determiner 62.

At operation 98, it is determined whether the received packet is an authorization packet, if at operation 96 it is determined that the received packet is an unauthentication (not an authentication) packet. The authorization packet comprises a third identifier identifying at least one of the first through Nth data processors 40, . . . , and 42 transceiving data and a port. Further, the third identifier may comprise information identifying one of the first through Nth data processors 40, . . . , and 42, which is assigned to the authenticated user in advance, a port number as well as additional information identifying other data processors and corresponding port numbers. For example, the third identifier can include at least one network protocol address and at least one corresponding port, e.g., a port 631 which can also be assigned in advance to the user from among a plurality of ports that can be included in the assigned data processor. The port 631 is a well-known port defined in a request for comment (RFC) 2565 for Internet Printing Protocol (IPP).

In FIG. 5, at operations 94 and 98, the packet discriminator 68 discriminates whether the received packet input from the packet receiver 60 is an authentication packet or an authorization packet, in response to the authentication control signal and the authorization control signal, respectively, input from the authentication checker 64 and the authorization checker 70 and outputs the discriminated result as a packet discrimination signal to the packet receiver 60, the authentication determiner 62, and the authorization determiner 72, respectively.

According to an aspect of the present invention, the previously described authentication and authorization packets may each be constituted as a specific format according to the user's intension. For example, the authentication or authorization packet may have a format according to a procedure used in an application program, such as a file transfer protocol or a Telnet protocol.

More particularly, at operation 100, authorization or unauthorization is determined using the authorization, if, at operation 98, it is determined that the received packet is the authorization packet. After operation 100, the authentication and authorization process 10B restarts at operation 90. In particular, at operation 100, the authorization determiner 72 analyzes the authorization packet input from the packet receiver 60 in response to the packet discrimination signal input from the packet discriminator 68 and determines authorization or unauthorization based on the analyzed result. The authorization determiner 72 outputs the determined authorization or unauthorization as a receiving control signal to the packet receiver 60 and outputs the determined authorization or unauthorization to the authorization checker 70.

If, at operation 92, it is determined that the user's data transceiving with one of the first through Nth data processors 40, . . . , and 42 is authenticated and authorized, at operation 12, data can be transmitted between the authenticated user and the authorized data processor. In particular, if, at operation 92, the user's data transceiving is authenticated and authorized, at operation 102, it is determined whether a packet received from the packet receiver 60 contains data to be processed in a corresponding data processor. Further, at operation 102, the packet checker 66 of the control signal generator 32B checks whether the packet received from the packet receiver 60 contains data to be processed in the corresponding data processor in response to the authentication and authorization control signals, respectively, input from the authentication checker 64 and the authorization checker 70, and outputs the checked result to the data transmission controller 34 via the output node OUT3. For example, the packet checker 66 performing operation 56 or 102 may check whether the packet received from the packet receiver 60 is an IPP packet.

Operation 12 starts if, at operation 102, it is determined that the received packet contains data to be processed. In other words, the data transmission controller 34 performs operation 12, in response to the checked result output from the packet checker 66 via the output node OUT3. However, if, at operation 102, it is determined that the received packet does not contain data to be processed, at operation 104, the received packet is thrown away and the authentication and authorization process 10B restarts at operation 90. In other words, the packet receiver 60 throws away the packet received from the input node IN2 in response to the checked result as a receiving control signal input from the packet checker 66 and the packet receiver 60 receives a new packet via the input node IN2. Also, if, at operation 98, it is determined that the received packet is an unauthorization packet, at operation 104, the packet receiver 60 throws away the packet received from the input node IN2 in response to the packet discrimination signal as the discriminated result input from the packet discriminator 68, and the packet receiver 60 receives a new packet via the input node IN2. In other words, if the packet received from the packet receiver 60 is not an authentication and authorization pattern or does not contain data to be processed, at operations 59 or 104, the received packet is treated as an undefined packet and thus thrown away.

In FIG. 1, at operation 12, according to the second embodiment of operation 10, data communication is performed via only a corresponding data processor and a port identified by the third identifier. In such a case, because an external user can use only the authorized data processor(s) and port(s), advantageously, other data processors and resources (e.g., a print connection) related thereto can be prevented from being opened by authenticated but unauthorized users.

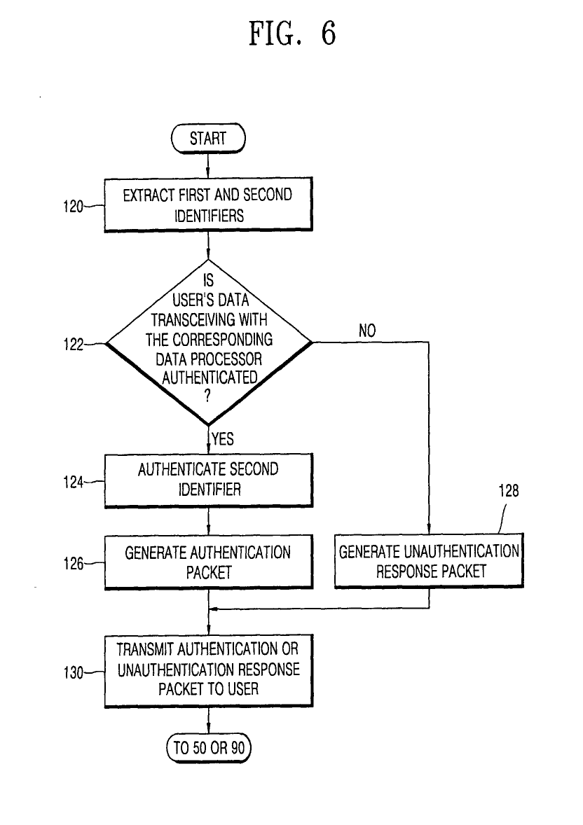

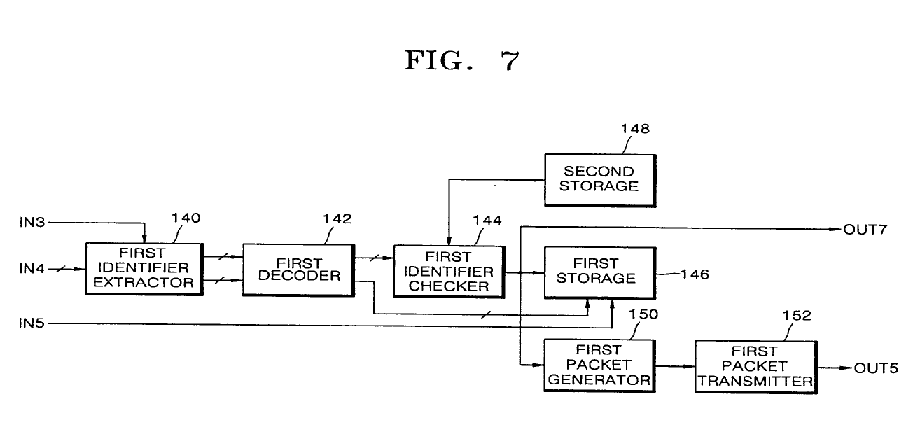

Hereinafter, an embodiment of operation 54 or 96 shown in FIGS. 3 or 5 and a configuration and operation of an embodiment of the authentication determiner 62 performing the embodiment of operation 54 or 96 will be described with reference to FIGS. 6 and 7.

FIG. 6 is a flowchart of an embodiment of operation 54 or 96 shown in FIGS. 3 or 5 and comprising operations 120 through 124 of determining authentication or unauthentication using extracted first and second identifiers and operations 126 through 130 of generating and transmitting a response packet generated based on the authentication or unauthentication.

FIG. 7 is a block diagram of an embodiment of the authentication determiner 62 performing the embodiment of operation 54 or 96 shown in FIG. 6 of the present invention. The authentication determiner 62 comprises a first identifier extractor 140, a first decoder 142, a first identifier 144, first and second storages 146 and 148, a first packet generator 150, and a first packet transmitter 152.

If, at operation 52 in FIG. 3, it is determined that the user's transceiving of data with the corresponding data processor is not authenticated or, if, at operation 94 in FIG. 5, the received packet is the authentication packet, at operation 120, first and second identifiers are extracted from the received packet. In particular, at operation 120, the first identifier extractor 140 extracts first and second identifiers from a packet received from the packet receiver 60 via an input node IN4 when it is perceived (determined) that the user's transceiving of data with the corresponding data processor is not authenticated based on an authentication control signal input from the authentication checker 64 via the input node IN3, or when it is perceived that the received packet is an authentication packet based on a packet discrimination signal input from the packet discriminator 68 via the input node IN3 and the first identifier extractor 140 outputs the extracted first and second identifiers to the first decoder 142.

According to an aspect of the present invention, a user (e.g., an individual user at a computer, a computer) can encode at least one of the first and second identifiers and transmit a packet including the encoded result to the data interfacing apparatus 30. In this case, at operation 50 or 90, the packet receiver 60 receives the encoded at least one of the first and second identifiers from the user via the input node IN2. Further, at operation 120, the first encoder 142 decodes any encoded first and second identifiers input from the first identifier extractor 140 and outputs the decoded result to the first identifier checker 144 and to the first storage 146, respectively.

At operation 122, it is determined whether the user's transceiving of data with a corresponding one of the first through Nth data processors 40, . . . , and 42 is authenticated, using the first identifier. In particular, at operation 122, the first identifier checker 144 determines authentication or unauthentication based on the decoded first identifier input from the first decoder 142 and outputs the determined authentication or unauthentication to the authentication checker 64 and the first storage 146 via an output node OUT7.

If, at operation 122, it is determined that the user's data transceiving with the corresponding data processor is authenticated, at operation 124, the decoded second identifier is registered. After operation 122, the authentication and/or authorization process 10 restarts at operation 50 or 90. In particular, at operation 122, the first storage 146 stores the decoded second identifier input from the first decoder 142, in response to the determined authentication or unauthentication input from the first identifier checker 144. Typically, at operations 52 or 92, the authentication or unauthentication is determined depending on whether the second identifier is stored in the first storage 146. Thus, if, at operation 124, it is determined that the second identifier is stored in the first storage 146, an authentication determination is made (i.e., an authentication determination at operation 52 or 92). If, at operation 124, it is determined that the second identifier is not stored in the first storage 146, an unauthentication determination is made (i.e., a no authentication determination at operation 52 or 92).

The second identifier authenticated in operation 124 may be released from being authenticated, when the user has completed/is done transceiving all data with one of the first through Nth data processors 40, . . . , and 42. In particular, the first storage 146 can eliminate the second identifier in response to a release control signal input from an input node IN5. Typically, the release control signal input from the input node IN5 is generated in the control signal generator 32 when the user has transceived all data with one of the first through Nth data processor 40, . . . , and 42, i.e., the user is disconnected from a corresponding one of the first through Nth data processor 40, . . . , and 42. Typically, the control signal generator 32 checks a response packet transceived between the user and the corresponding data processor to monitor/determine if data transceiving between the user and the corresponding data processor has been finished/terminated.

Meanwhile, the first decoder 142 shown in FIG. 7 may be omitted if the user does not encode the first and second identifiers. In this case, the first identifier checker 144 determines authentication or unauthentication based on the first identifier extracted from the first identifier extractor 140 and the first storage 146 stores the second identifier input from the first identifier extractor 140.

According to an aspect of the present invention, as shown in FIG. 7, the authentication determiner 62 may further comprise the second storage 148. In particular, the second storage 148 stores a first reference identifier. Further, at operation 122, the first identifier checker 144 compares the first reference identifier read from the second storage 148 with the extracted first identifier and outputs the compared result as a determined authentication or unauthentication via the output node OUT7. Here, if the first identifier is an ID and password of the user, the second storage 148 stores authenticable ID and password of at least one user as the first reference identifier in advance. When an external user request authentication, at operation 122, the first identifier checker 144 can compare the first reference identifier stored in the second storage 148 with the extracted first identifier to determine authentication or unauthentication.

Also, the second storage 148, which can organize authenticable IDs and passwords of users as a database, can store priority information on priority of the users. In this case, at operation 122, the first identifier checker 144 authenticates an external user based upon the priority information stored in the second storage 148, if another external user requests authentication during authentication of another external user. Here, priority information may contain a matching relationship between the priority and IDs and/or passwords of the users.

The present invention is not limited to the example implementation of the second storage 148 in the authentication determiner 62, such that the second storage 148 may be implemented using known techniques separate from and in communication via an interface with the authentication determiner 62.

If the operations 56 and 58 shown in FIG. 3 are not prepared, i.e., the packet checker 66 shown in FIG. 4 is not prepared, the packet receiver 60 of the control signal generator 32A receives a packet via the input node IN2, in response to the authentication or unauthentication determined in the first identifier checker 144. In other words, the packet receiver 60 can receive or is ready to receive a packet containing data to be processed in a corresponding one of the first through Nth data processors 40, . . . , and 42 via the input node IN2, if the authentication is perceived (determined) at operation 54 or 96 through the determined result input from the first identifier checker 144 and there is data to be processed in an authenticated packet. Of course, the packet receiver 60 does not receive data to be processed via the input node IN2, if the unauthentication is perceived (determined) at operation 52 through the determined result input from the first identifier checker 144. In other words, the packet receiver 60 receives the authentication or unauthentication determined in the first identifier checker 144 as a receiving control signal.

According to an aspect of the present invention, operations 126, 128, and 130 may be further performed. In this case, at operation 126, an authentication response packet representing user authentication is generated. If, at operations 122 or 124, unauthentication is determined, at operation 128 an unauthentication response packet representing user unauthentication is generated. In particular, at operation 126 and 128, the packet generator 150 shown in FIG. 7 generates the authentication or unauthentication response packet, in response to the determined authentication or unauthentication input from the identifier checker 144 and outputs the generated authentication or unauthentication response packet to the first packet transmitter 152.

After operation 126 or 128, at operation 130, the generated authentication or unauthentication response packet is transmitted to the user and the authentication and/or authorization process 10 restarts at operation 50 or 90. In particular, the first packet transmitter 152 outputs the authentication or unauthentication response packet input from the first packet generator 150 to the user via an output node OUT5. Further, the user determines to be authenticated via the data interfacing apparatus 30, when the user receives the authentication response packet transmitted from the first packet transmitter 152 of FIG. 7. After determining to be authenticated, the user provides data to be processed to one of the first through Nth data processors 40, . . . , and 42, if the data interfacing apparatus 30 requests only authentication as shown in FIG. 3. Otherwise, the user transmits an authorization packet requesting authorization to the data interfacing apparatus 30, if the data interfacing apparatus 30 requests authentication and authorization as shown in FIG. 5. The user can request authentication from the data interfacing apparatus 30 again when the user receives the unauthentication response packet transmitted from the first packet transmitter 152. If the user request authentication again, typically the user re-transmits the first identifier to the data interfacing apparatus 30.

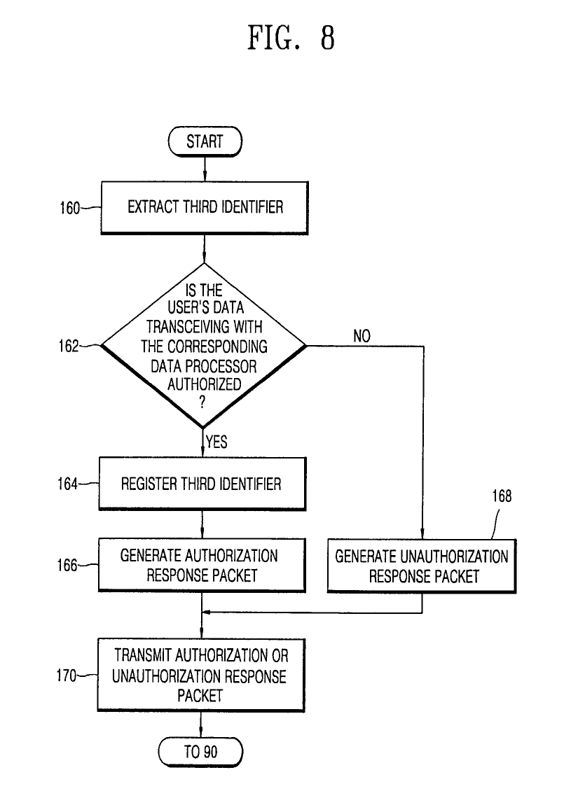

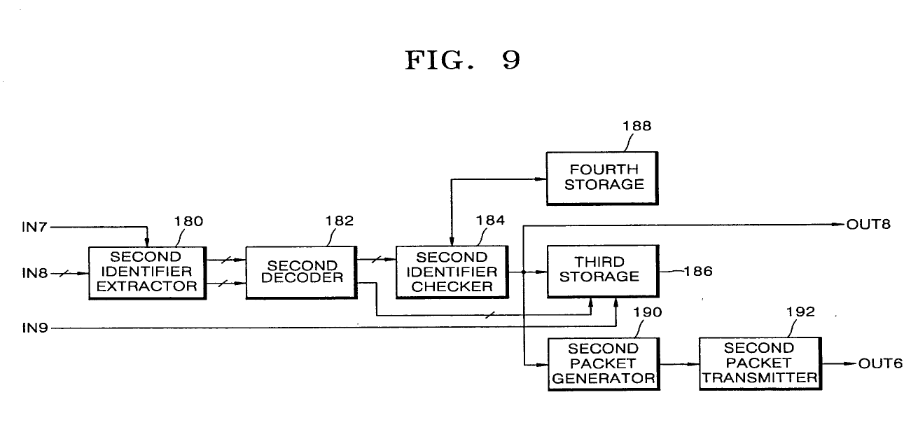

Hereinafter, an embodiment of operation 100 shown in FIG. 5 and a configuration and operation of an embodiment of the authorization determiner 72 performing the embodiment of operation 100 will be described with reference to FIGS. 8 and 9.

FIG. 8 is a flowchart of an embodiment of operation 100 shown in FIG. 5 and comprises operations 160 through 164 of determining authorization or unauthorization using an extracted third identifier and operations 166 through 170 of generating and transmitting a response packet based on the authorization or unauthorization.

FIG. 9 is a block diagram of an embodiment of the authorization determiner 72 performing the embodiment of operation 100 shown in FIG. 8. Here, the authorization determiner 72 comprises a second identifier extractor 180, a second decoder 182, a second identifier checker 184, third and fourth storages 186 and 188, a second packet generator 190, and a second packet transmitter 192.

At operation 160, a third identifier is extracted from a received authorization packet, if, at operation 98 shown in FIG. 5, it is determined that the received packet is an authorization packet. In particular, the second identifier extractor 180 extracts the third identifier from a packet input from the packet receiver 60 via an input node IN8, in response to a packet discrimination signal input from the packet discriminator 68 via an input node IN7 and outputs the extracted third identifier to the second decoder 182.

According to an aspect of the present invention, a user (e.g., an individual user, a computer) can encode the third identifier and transmit a packet containing the encoded third identifier to the data interfacing apparatus 30. In this case, at operation 90, the third identifier is encoded and input by the user to the packet receiver 60 via the input node IN2. Further, at operation 160, the second decoder 182 decodes the third identifier input from the second identifier extractor 180 and outputs the decoded third identifier to the second identifier checker 184 and to the third storage 186, respectively.

At operation 162, it is determined whether the user's transceiving of data with a corresponding one of the first through Nth data processors 40, . . . , and 42 is authorized using the extracted third identifier. In other words, at operation 162, it is determined whether the user's transceiving of data with a data processor 40, . . . or 42 and a corresponding port represented by the third identifier is authorized. In particular, the second identifier checker 184 determines authorization or unauthorization based on the third identifier and outputs the determined authorization or unauthorization to the authorization checker 70 via an output node OUT8.

If, at operation 162, it is determined that the user's transceiving of data with the corresponding data processor is authorized, at operation 164, the extracted third identifier is registered. After operation 164, the authentication and authorization process restarts 10B at operation 90. In particular, at operation 164, the third storage 186 stores the decoded third identifier input from the second decoder 182, in response to the determined authorization or unauthorization input from the second identifier checker 184. Typically, at operation 92, the authorization or unauthorization is determined if the third identifier is stored in the third storage 186. Thus, if, at operation 164, it is determined that the third identifier is stored in third storage 186, an authorization determination is made (i.e., an authorization determination at operation 92) and if, at operation 164, it is determined that the third identifier is not stored in the third storage 186, an unauthorization determination is made (i.e., a no authorization determination at operation 92).

At operation 164, registration of the third identifier may be released (expired) when the user has completed/is done data transceiving with the corresponding data processor. In particular, the third storage 186 can eliminate the third identifier in response to a release control signal input from an input node IN9. Typically, the release control signal input from the input node IN9 is generated in the control signal generator 32 when the user has transceived all data with the corresponding data processor, i.e., when the user is disconnected from the corresponding data processor. Typically, the control signal generator 32 checks a response packet transceived between the user and the corresponding data processor to monitor/determine if data transceiving between the user and the corresponding data processor has been finished/terminated.

Meanwhile, the second decoder 182 shown in FIG. 9 may be omitted if the user does not encode the third identifier. In this case, the second identifier checker 184 determines authorization or unauthorization based on the third identifier extracted from the second identifier extractor 180 and the third storage 186 stores the third identifier input from the second identifier extractor 180.

According to an aspect of the present invention, as shown in FIG. 9, the authorization determiner 72 may further comprise a fourth storage 188. In particular, the fourth storage 188 stores a second reference identifier (i.e., a database of second reference identifiers). Further, at operation 162, the second identifier checker 184 compares the second reference identifier read from the fourth storage 188 with the extracted third identifier and outputs the compared result as a determined authorization or unauthorization via the output node OUT8. Here, if the third identifier is an identification number of a data processor 40, . . . or 42 with which the user wants to process data and a corresponding identification number of a port included in the data processor regardless of the relationship between the third identifier and the user, the fourth storage 188 stores, in advance, information identifying at least one authorizable data processor and at least one corresponding port, as the second reference identifier. When an external user requests an authorization, the second identifier checker 184 can compare the second reference identifier stored in the fourth storage 188 with the extracted third identifier to determine authorization or unauthorization of the data processor and the port requested by the user.

The present invention is not limited to the example implementation of the fourth storage 188 in the authorization determiner 72, such that the fourth storage 188 may be implemented using known techniques separate from and in communication via an interface with the authorization determiner 72.

The packet receiver 60 of the control signal generator 32B receives a packet via the input node IN2, in response to the authorization or unauthorization determined in the second identifier checker 184, if operations 102 and 104 shown in FIG. 5 are not prepared, i.e., if the packet checker 66 shown in FIG. 4 is not prepared. In other words, the packet receiver 60 can receive or is ready to receive a packet containing data to be processed in one of the first through Nth data processors 40, . . . , and 42 via the input node IN2, if the authorization is perceived (determined) at operation 92 through the determined result input from the second identifier checker 184 of the authorization determiner 72 and there is data to be processed in an unauthenticated and authorized packet. However, the packet receiver 60 does not receive data to be processed via the input node IN2, if the unauthorization is perceived (determined) at operation 90 through the determined result input from the second identifier checker 184 of the authorization determiner 72. In other words, the packet receiver 60 receives the authorization or unauthorization determined in the second identifier checker 184 as a receiving control signal.

According to an aspect of the present invention, operations 166, 168, and 170 may further be performed. In this case, at operation 166, an authorization response packet representing authorization of a corresponding data processor requested by the user is generated. If at operation 162, the unauthorization is determined, at operation 168 an unauthorization response packet representing unauthorization of the corresponding data processor requested by the user is generated. In particular, at operations 166 and 168, the second packet generator 190 shown in FIG. 9 generates the authorization or unauthorization response packet in response to the authorization or unauthorization determined in the second identifier checker 184 and outputs the authorization or unauthorization response packet to the second packet transmitter 192.

After operation 166 or 168, at operation 170, the authorization or unauthorization response packet is transmitted to the user and the authentication and authorization process 10B restarts at operation 90. In particular, the second packet transmitter 192 outputs the authorization or unauthorization response packet input from the second packet generator 190 to the user via an output node OUT6. Further, the user determines to be authorized via the data interfacing apparatus 30, when the user receives the authorization response packet transmitted via the second packet transmitter 192 shown in FIG. 9 and the user provides data to be processed to an authorized one of the first through Nth data processors 40, . . . , and 42. The user can request authorization from the data interfacing apparatus 30 again when the user receives the unauthorization response packet transmitted via the second packet transmitter 192. If the user requests the authorization again, typically the user re-transmits the previously transmitted or a regenerated third identifier to the data interfacing apparatus 30.

According to an aspect of the invention, a single packet transmitter (not shown) may be provided to transmit to the user the authentication response packet, the unauthentication response packet, the authorization response packet, and the unauthorization response packet output from the control signal generator 32 shown in FIGS. 2 or 4 via the output nodes OUT1, OUT5, or OUT6, and to transmit to the user data processed in a corresponding data processor and output from the data interfacing apparatus 30 shown in FIG. 2 via the output node OUT1.

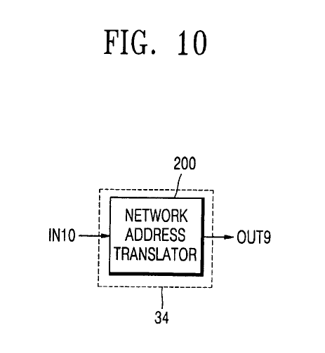

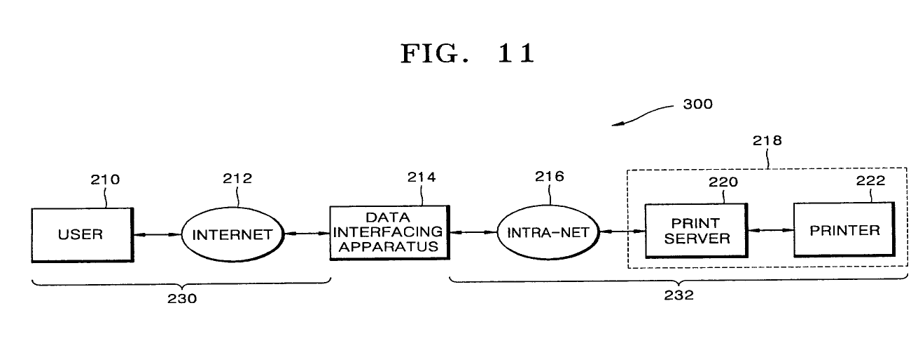

FIG. 10 is a block diagram of the data transmission controller 34 shown in FIG. 2, according to an embodiment of the present invention. The data transmission controller 34 comprises a network address translator (NAT) 200. The NAT 200, which provides security and a virtual private network, reorganizes data input from an input node IN10 via the control signal generator 32 from an authenticated and/or authorized user and outputs the reorganized result to one of the first through Nth data processors 40, . . . , and 42 via an output node OUT9. Also, the NAT 200 reorganizes data that has been processed in one of the first through Nth data processors 40, . . . , and 42 and input from the input node IN10, and outputs the reorganized result to the user via the output node OUT9.

FIG. 11 is block diagram of a data communication system 300 using the data interface system shown in FIG. 2. In particular, at least one of the nth data processors 40, . . . , or 42 serves as a printer and the data interfacing apparatus 30 serves as a firewall. Further, data is communicated between a user and the data interfacing apparatus 30 via the Internet, and the data is communicated between the data interfacing apparatus 30 and one of the first through Nth data processors 40, . . . , and 42 via an Intra-net (or Local Area Network). In FIG. 11, the data communication system 300 comprises a user 210 (e.g., an individual user at a client computer, or a client computer), Internet network 212, a data interfacing apparatus (computer system) 214, which corresponds to the data interfacing apparatus (computer system) 30 shown in FIG. 2, Intra-net network 216, and an nth data processor 218 having a print server 220 and a printer 222.

In particular, typically in the context of security, an area 232 can be referred to as the Intranet 232 and an area 230 can be referred to as the Internet 230. The data interfacing apparatus 214 serves as a firewall, safely protecting user information entering or leaving the Intranet 232. In other words, the data interfacing apparatus 214 intercepts the drain (retrieval) of information from the Intranet 232 or intercepts data entering the Intranet 232 for use of resources (i.e., data processors and resources thereof) of the Intranet 232, by an unauthenticated and/or unauthorized user 210.

For example, if the user 210 wants to use the printer 222, the user 210 transmits data necessary for authentication and/or authorization to the data interfacing apparatus 214 via the Internet network 212 in a data packet. Here, the data interfacing apparatus 214 determines whether the user's 210 transceiving of data with the nth data processor 218 is authenticated and/or authorized. If data transceiving with the nth data processor 218 by the user 210 is authenticated and/or authorized, the user 210 can transmit data that the user wants to print, via a port 631 or the like through the Internet network 212, the data interfacing apparatus 214, the Intra-net network 216, and the print server 220, to the printer 222. If the user 210 wants to check a state of the printer 222, the user 210 can transmit data necessary for testing the printer 222 to the nth data processor 218 and receive data having information on the state of the printer 222 via the Intra-net network 216, the data interfacing apparatus 214, and the Internet network 212. However, if the data transceiving with the nth data processor 218 by the user 210 is unauthenticated and/or unauthorized, the user 210 cannot use the nth data processor 218 of the Intranet 232 or check the state of the nth data processor 218.

Further, in FIG. 11, the NAT 200 of the data interfacing apparatus 14 translates an incoming Internet Protocol Address (IPA) to an IPA used by the Intranet 232 and not open(known) to the Internet 230. Thus, another IPA different from the IPA used by the Intranet 232 is communicated to the Internet 230. In other words, the NAT 200 translates the IPA opened to the Internet 230 into the IPA used by the Intranet 232 to reorganize a packet or translates the IPA used by the Intranet 232 into the IPA opened to the Internet 230 to reorganize the packet.

Here, the print server 220 transmits an IPP response packet to the data interfacing apparatus 214 via the Intra-net network 216 when the print server 220 processes an IPP packet. The data interfacing apparatus 214 transmits the IPP response packet to the user 210 via the Internet network 212. Thus, the user 210 can determine that the IPP response packet was processed by the print server 220 and transmits a next necessary IPP packet to the nth data processor 218 via the Internet network 212, the data interfacing apparatus 214, and the Intra-net network 216.

As described above, in a data interfacing method and an apparatus therefor according to the present invention, an authenticated and/or authorized external user can use a corresponding data processor, e.g., a printer, of a private network and/or can check a state of the printer in advance or in real-time. Also, unlike a conventional data interfacing apparatus serving as firewall in which specific application software is set so that a firewall manager passes only a specific protocol allowing access to all predetermined available resources of a private network, in the present invention, authentication and/or authorization is identified packetwise at a lower layer than at least a transport layer in the firewall (i.e.; by monitoring each data packet exchanged between an external user and resources of the private network to authenticate and/or authorize each data packet), without setting specific application software, to use a data processor and/or to check a state of the data processor. Therefore, in the system 300 the user 210 can only access a data processor and resources thereof in the Intranet 232 assigned to the user and other data processors and resources thereof can be protected. Further, in case of simultaneous transmissions from users to one data processor, at operation 52 and 92, the system determines authentication/authorization according to the predetermined priorities of the users.

For example, if the data interfacing apparatus 214 and method thereof are applied for Internet printing, first, second, and third identifiers provided from an external user are stored as a logging file in the data interfacing apparatus 214 to monitor a packet input from the external user for authentication and/or authorization. Thus, each user can be restricted to access only certain resources of the private network. Thus, unnecessary advertising pamphlets and leaflets can be prevented from being printed by an unauthenticated and/or unauthorized external user, because unauthenticated and/or unauthorized external users are not allowed to use printing functions of a private network printer, that is, are not allowed to use one of the first through Nth data processors 40, . . . , and 42. Further, if the external user is authenticated and/or authorized, the user can use a corresponding data processor and/or check a state of the corresponding data processor. Thus, a trouble state of the data processor, e.g., a trouble state of the printer, can be remotely checked via a network, accommodating scheduling/requesting service for the printer prior to checking the physical printer. Although the authentication and the authorization packets may be transmitted to and analyzed separately by the interface apparatus 30, the present invention's authorization/authentication process 10 is not limited to such a configuration, and authentication and authorization information can be transmitted in a single packet and analyzed accordingly by the interface apparatus 30. Further, the determiners 62 and 68, the discriminator 68 and packet checker 66 may be deemed as an authorizer 65, determining authentication and/or authorization. Processes of the invention, providing a packetwise authentication and/or authorization of communicated data via authentication and/or authorization control signals, can be embodied in hardware and software thereof using known techniques to provide an interface controller of the invention in a computer.

Although a few preferred embodiments of the present invention have been shown and described, it would be appreciated by those skilled in the art that changes may be made in the embodiments without departing from the principles and spirit of the invention, the scope of which is defined in the claims and their equivalents.

What is claimed is:

1. A method of interfacing an external user with at least one data processor having at least one port, the method comprising:
determining whether the user's transceiving of data with the data processor in a received packet is authenticated, thereby authenticating the user; and
transmitting the data provided from the authenticated user to the data processor or transmitting the data provided from the data processor to the authenticated user, if it is determined that the user's transceiving of data with the data processor is authenticated,
wherein the data processor processes the data provided from the user.

2. The method of claim 1, further comprising:
determining whether the authenticated user's transceiving of the data with the data processor is authorized using the received packet, thereby providing an authorized data processor; and
transmitting the data provided from the authenticated user to the authorized data processor or transmitting the data provided from the authorized data processor to the authenticated user, if it is determined that the authenticated user's transceiving of data with the data processor is authorized.

3. The method of claim 2, wherein the determination of the authenticated user and the authorized data processor comprises:
receiving the packet from the user;
determining authentication or unauthentication using the received packet and receiving a new packet, if the user's transceiving of the data with the data processor is unauthenticated; and
checking whether the user's transceiving of the data with the data processor is authorized, if the user's transceiving of the data with the data processor is authenticated.

4. The method of claim 3, wherein the determination of the authenticated user comprises:
extracting first and second identifiers from the received packet;
determining whether the user's transceiving of the data with the data processor is authenticated, using the extracted first identifier; and
authenticating the extracted second identifier,
wherein the first identifier represents the user, the second identifier represents the data processor related to the user and the data is transmitted to the data processor, if the second identifier is authenticated, and checking whether the received packet is authenticated, if it is determined that the second identifier is unauthenticated.

5. The method of claim 4, wherein the first identifier corresponds to at least one of an identification number and a password of the user.

6. The method of claim 4, wherein the second identifier corresponds to a network protocol address of the data processor related to the user.

7. The method of claim 4, wherein at least one of the first and second identifiers is encoded and transmitted from the user, and the extraction of the first and second identifier further comprises decoding the at least one of the encoded first and second identifiers.

8. The method of claim 4, wherein an authentication state of the authenticated second identifier is released when the user completes data transceiving with the data processor.

9. The method of claim 4, wherein the determination of the authenticated user and the authorized data processor comprises:
checking whether the received packet is an authentication packet and determining the authentication or authentication, if the received packet is the authentication packet; and
checking whether the received packet is an authorization packet, if the received packet is not the authentication packet and determining authorization or unauthorization, if the received packet is the authorization packet,
wherein it is checked whether the received packet is the authentication packet, if it is determined that the user's transceiving of the data with the data processor is unauthenticated or unauthorized and another packet is received and data to be processed is transmitted to the data processor, if it is determined that the user's transceiving of the data with the data processor is authenticated and authorized.

10. The method of claim 9, wherein at least one of the authentication packet and the authorization packet has a format according to a file transfer protocol application program.

11. The method of claim 9, wherein at least one of the authentication packet and the authorization packet has a format according to a Telnet protocol application program.

12. The method of claim 9, wherein the determination of the authenticated user and the authorized user comprises:
determining whether the received packet includes the data to be processed in the data processor, if the user's transceiving of the data with the data processor is authenticated and authorized and transmitting the data, if the received packet includes the data to be processed; and
discarding the received packet and receiving another packet, if the received packet does not include the data to be processed.

13. The method of claim 3, wherein the determination of the authenticated user comprises:
determining whether the received packet includes the data to be processed in the data processor, if the user's transceiving of the data with the data processor is authenticated and transmitting the data, if the received packet includes the data to be processed; and
discarding the received packet and receiving another packet, if the received packet does not include the data to be processed.

14. The method of claim 9, wherein the packet is discarded, if the received packet is not the authorization packet.

15. The method of claim 9, wherein the authentication packet includes the first identifier representing the user and the second identifier representing the data processor related to the user, and the authorization packet includes a third identifier representing at least one of the data processor and a port number in the data processor for transceiving the data.

16. The method of claim 15, wherein the third identifier includes a network protocol address.

17. The method of claim 15, wherein the port number is 631.

18. The method of claim 15, wherein the determination of the authorized data processor comprises:
extracting the third identifier from the received authorization packet;
determining whether the user's transceiving of the data with the data processor and the port represented by the third identifier is authorized; and
registering the third identifier,
wherein another packet is received and data to be processed is transmitted to the data processor, if the third identifier is registered and checking whether the received packet is the authorization packet is performed, if it is determined that the third identifier is not registered.

19. The method of claim 18, wherein the third identifier is encoded and transmitted from the user, and the extraction of the third identifier further comprises decoding the encoded third identifier.

20. The method of claim 18, wherein the registered third identifier is released from being registered when the user completes the transceiving the data with the data processor.

21. The method of claim 4, wherein the determination of the authenticated user further comprises:
generating an authentication response packet, if the user's data transceiving with the data processor is authenticated;
generating an unauthentication response packet if the user's transceiving of the data with the data processor is unauthenticated; and
transmitting the generated authentication or unauthentication response packet to the user,
wherein the user perceives to be authenticated when receiving the authentication response packet and provides the data to be processed in the data processor to the data processor.

22. The method of claim 18, wherein the determination of the authorized data processor further comprises:
generating an authorization response packet, if the user's data transceiving with the data processor is authorized;
generating an unauthorization response packet if the user's transceiving of the data with the data processor is unauthorized; and
transmitting the generated authorization or unauthorization response packet to the user,
wherein the user perceives to be authorized when receiving the authorization response packet and provides the data to be processed in the data processor to the authorized data processor.

23. The method of claim 1, wherein the data processor corresponds to a printer and prints information corresponding to the data.

24. The method of claim 1, wherein the data processor checks a state thereof corresponding to the data provided from the user.

25. The method of claim 1, wherein the data is received from the user via a network.

26. The method of claim 25, wherein the data received from the user is provided to the data processor via another network.

27. The method of claim 26, wherein, the data received from the authenticated user is reorganized and transmitted to the data processor or the data received from the data processor is reorganized and transmitted to the user.

28. An apparatus interfacing an external user with at least one data processor having at least one port, the apparatus comprising:
a control signal generator determining whether the user's transceiving of data with the data processor in a received packet is authenticated, thereby providing an authenticated user, and outputting an authentication control signal in response to the authentication determination; and
a data transmission controller outputting the data input from the authenticated user to the data processor or outputting the data input from the data processor to the authenticated user, in response to the authentication control signal,
wherein the data processor processes the data input from the user via the data transmission controller.

29. The apparatus of claim 28, wherein the control signal generator determines whether the authenticated user's transceiving of the data with the data processor is authorized, thereby providing an authorized data processor, and outputs an authorization control signal, in response to the authorization determination, and the data transmission controller outputs the data input from the authenticated user to the authorized data processor or outputs the data input from the authorized data processor to the authenticated user, in response to the authorization control signal.

30. The apparatus of claim 29, wherein the control signal generator comprises:
a packet receiver receiving the packet from the user in response to a receiving control signal;
an authentication checker checking from a determined authentication or unauthentication whether the user's transceiving of the data with the data processor is authenticated and outputting the checked result as the authentication control signal; and
an authentication determiner analyzing the packet input from the packet receiver in response to the authentication control signal, determining authentication or unauthentication based on the analyzed result, generating the receiving control signal in response to the determined authentication or unauthentication, and outputting the determined authentication or unauthentication to the authentication checker.

31. The apparatus of claim 30, wherein the authentication determiner comprises:
a first identifier extractor extracting first and second identifiers from the received packet in response to the authentication control signal;
a first identifier checker determining and outputting the authentication or unauthetication from the first identifier; and
a first storage storing the extracted second identifier in response to the determined authentication or unauthentication input from the first identifier checker and outputting the determined authentication or unauthentication to the authentication checker,
wherein the receiving control signal is generated corresponding to the determined authentication or unauthentication, the first identifier represents the user, and the second identifier represents the data processor related to the user, and the authentication checker checks whether the second identifier is stored in the first storage to generate the authentication control signal in response to the checked result as the authentication or unauthentication.

32. The apparatus of claim 31, wherein the control signal generator further comprises a second storage storing a first reference identifier, and the first identifier checker compares the first reference identifier read from the second storage with the first identifier input from the first identifier extractor and outputs the compared result as the determined authentication or unauthentication.

33. The apparatus of claim 32, wherein the second storage is included in the authentication determiner.

34. The apparatus of claim 32, wherein the second storage stores information on priority of the users.

35. The apparatus of claim 31, wherein the authentication determiner further comprises a first decoder decoding at least one of encoded first and second identifiers input from the first identifier extractor and outputs the decoded result to the first identifier checker and the first storage, respectively,

36. The apparatus of claim 31, wherein the first storage removes the stored second identifier in response to a release control signal generated when the user completes data transceiving with the data processor.

37. The apparatus of claim 30, wherein the control signal generator further comprises:
a packet discriminator discriminating whether the received packet is an authentication packet or an authorization packet in response to the authentication and authorization control signals and outputting the discriminated result as a packet discrimination signal to the authentication determiner and the authorization determiner;
an authorization checker checking from a determined authorization or unauthorization whether the user's transceiving of the data with the data processor is authorized and outputting the checked result as the authorization control signal; and
an authorization determiner analyzing the authorization packet input from the packet receiver in response to the packet discrimination signal, determining authorization or unauthorization from the analyzed result, generating the receiving control signal in response to the determined authorization or unauthorization, and outputting the determined authorization or unauthorization to the authorization checker,
wherein the authentication determiner operates in response to the packet discrimination signal.

38. The apparatus of claim 37,
wherein the control signal generator further comprises a packet checker checking whether the received packet includes data to be processed in the data processor in response to the authentication and authorization control signals and outputting the checked result, and
wherein either the data transmission controller operates in response to the result checked in the packet checker, or the packet receiver discards the received packet in response to the checked result input from the packet checker and receives a new packet.

39. The apparatus of claim 30,
wherein the control signal generator further comprises a packet checker checking whether the received packet includes data to be processed in the data processor in response to the authentication control signal and outputting the checked result, and
wherein either the data transmission controller operates in response to the result checked in the packet checker, or the packet receiver discards the received packet in response to the checked result input from the packet checker and receives a new packet.

40. The apparatus of claim 38, wherein the packet receiver discards the received packet in response to the packet discrimination signal and receives the new packet.

41. The apparatus of claim 37, wherein the authentication packet includes a first identifier representing the user and a second identifier representing the data processor related to the user, and the authorization packet includes a third identifier representing at least one of the data processor and a port number in the data processor for transceiving the data.

42. The apparatus of claim 41, wherein the authorization determiner comprises:
a second identifier extractor extracting the third identifier from the received authorization packet in response to the packet discrimination signal;
a second identifier checker determining the authorization or unauthorization from the third identifier and outputting the determined authorization or unauthorization to the authorization checker; and
a third storage storing the extracted third identifier in response to the determined authorization or unauthorization input from the second identifier checker,
wherein the packet receiver receives the authorization or unauthorization determined in the second identifier checker as the receiving control signal, and the authorization checker checks whether the third identifier is stored in the third storage to generate the authorization control signal in response to the checked result.

43. The apparatus of claim 42, wherein the control signal generator further comprises a fourth storage which stores a second reference identifier, and the second identifier checker compares the second reference identifier read from the fourth storage with the third identifier input from the second identifier extractor and outputs the compared result as the determined authorization or unauthorization.

44. The apparatus of claim 43, wherein the fourth storage is included in the authorization determiner.

45. The apparatus of claim 42, wherein the authorization determiner further comprises a second decoder decoding an encoded third identifier input from the second identifier extractor and outputs the decoded result to the second identifier checker and the third storage.

46. The apparatus of claim 42, wherein the third identifier stored in the third storage is removed in response to a release control signal generated when the user completes data transceiving with the data processor.

47. The apparatus of claim 31, wherein the authentication determiner further comprises:
a first packet generator generating and outputting an authentication or unauthentication response packet in response to the determined result input from the first identifier checker; and
a first packet transmitter transmitting the authentication or unauthentication response packet input from the first packet generator to the user,
wherein the user transmits to the data processor data to be processed in the data processor in response to the authentication response packet.

48. The apparatus of claim 42, wherein the authorization determiner further comprises:
a second packet generator generating and outputting an authorization or unauthorization response packet in response to the determined result input from the second identifier checker; and
a second packet transmitter transmitting the authorization or unauthorization response packet input from the second packet generator to the user,
wherein the user transmits data to be processed in the data processor in response to the authorization response packet to the data processor.

49. The apparatus of claim 28, wherein the data transmission controller comprises a network address translator reorganizing the data input from the authenticated user and outputting the reorganized data to the data processor, or reorganizing the data input from the data processor and outputting the reorganized data to the user.

50. The apparatus of claim 28, wherein the data interfacing apparatus corresponds to a firewall.

51. An interface controller provided in a computer system to interface an external user with at least one data processor having at least one port, the controller comprising,
a control signal generator generating authentication and/or authorization control signals corresponding to authentication and/or authorization of data transceiving by the user using a data packet received from the user; and
a transmission controller outputting data to be processed by a data processor from the user, in response to the authentication and/or authorization control signals.
